(19) United States
(12) Patent Application Publication
(10) Pub. No.: US 2013/0222258 A1
(43) Pub. Date: Aug. 29, 2013

(54) MOBILE TERMINAL COMPRISING A CASING COMPRISING TWO MUTUALLY MOBILE PARTS

(71) Applicant: Fernando Romao, Leuven (BE)

(72) Inventor: Fernando Romao, Leuven (BE)

(73) Assignee: OPTION, Leuven (BE)

(21) Appl. No.: 13/825,714

(22) PCT Filed: Sep. 23, 2011
(86) PCT No.: PCT/EP11/66614

§ 371 Date: May 17, 2013

(30) Foreign Application Priority Data
Sep. 23, 2010 (FR) 1057637

(51) Int. Cl. G06F 1/16

(52) U.S. Cl. CPC G06F 1/1624
USPC 345/169

(57) ABSTRACT

A mobile terminal (1.0) comprises, in a casing, a plurality of elements including, at least, one screen (1.2), one keypad (1.11), one battery, one printed circuit on which is placed at least one central processor of the mobile terminal. The printed circuit is connected to the battery. The casing comprises a first part (1.1) comprising the screen and a second part (1.4) comprising the keypad, the second part of the casing being assembled in a mobile manner between a retracted position and a deployed position in a cavity (1.7) formed in the first part of the casing. The first part of the casing comprises a first element (1.8) from among the battery and the printed circuit, and the second part of the casing comprises the second element (1.9) from among the battery and the printed circuit. The first element from among the battery and the printed circuit and the cavity are positioned on both sides of a plane perpendicular to the screen.

The present invention relates to a mobile terminal comprising, in a casing, a plurality of elements including, at least, a screen, a battery, a keypad, a printed circuit on which is placed at least one processor. The casing comprises two mutually mobile parts.

Mobile terminals such as mobile telephones, PDAs (Personal Digital Assistants), multimedia readers or else tablet type personal computers (PC or Personal Computer tablet) are becoming more and more complex and offer increasingly numerous functionalities to their users. These functionalities are made accessible to a user of such a mobile terminal by means of a man-machine interface, typically comprising a screen, which may be a touch screen, and a keypad.

So as to give these mobile terminals a compact form, it is known that the casing of the mobile terminal comprises two mutually mobile parts. A first part of the casing then comprises the screen and some buttons, and a second part of the casing comprises the keypad. Therefore, for a large number of mobile terminal applications, the user uses the mobile terminal with the keypad in a retracted position, and then interacts with these applications thanks to the screen and possibly to some buttons mounted on the first part of the casing. For applications requiring a significant input of characters, the user deploys the keypad and then interacts with these applications thanks to the screen and to the keypad thus deployed.

A first embodiment of such a mobile terminal is for example described in the U.S. Pat. No. 7,633,745 entitled “Electronic device.” A second embodiment of such a mobile terminal is for example described in the patent application published under the reference U.S. 2010/035668 and entitled “Slide Hinge Module for Mobile Phone.”

One disadvantage of these embodiments from the prior art resides in the dimensions of the mobile terminals thus obtained, particularly in their thicknesses. Thickness of the mobile terminal is understood to mean the distance that separates the face of the mobile terminal where the screen is mounted and the opposite face.

Mitigating these different disadvantages from the prior art is desirable.

It is particularly desirable to reduce the dimensions of a mobile terminal comprising, in a casing, a plurality of elements including, at least, a screen, a keypad, a battery, a printed circuit on which is placed, at least, a processor, the casing being such that the keypad is mobile relative to the screen. Reducing the thickness of such a mobile terminal is particularly desirable.

It is also desirable that the part of the mobile terminal that comprises the keypad has a sufficient thickness to withstand keying of the keypad by the user, without being detrimental to the dimensions and particularly to the thickness of the mobile terminal.

The invention relates to a mobile terminal comprising a casing, a screen, a keypad, a battery and a printed circuit on which is placed at least a processor. Said casing comprises a first part comprising the screen and a second part comprising the keypad, the second part of the casing being assembled in a mobile manner in a cavity formed in the first part of the casing. The first part of the casing comprises a first element from among the battery and the printed circuit. The second part of the casing comprises the second element from among the battery and the printed circuit, and the first element and the cavity are positioned on both sides of a plane perpendicular to the screen.

Thus, superimposition of the assembly of the following three elements is avoided: the printed circuit, the keypad and the battery. The thickness of the mobile terminal is thus reduced with relation to the prior art. In addition, the part of the mobile terminal that comprises the keypad may have a sufficient thickness to withstand the keying of the keypad by the user, without being detrimental to the dimensions and particularly to the thickness of the mobile terminal.

According to a particular embodiment, the keypad being assembled substantially parallel to the screen, the second part of the casing is assembled in a mobile manner in the cavity by displacement means assembled on at least one face of the second part of the casing substantially perpendicular to that where the keypad is assembled.

Therefore, the reduction in the thickness of the mobile terminal is increased. In fact, one avoids having the displacement means influence the thickness of the mobile terminal.

According to a particular embodiment, the screen being mounted on a face of the mobile terminal, a face of said second part of the casing merges with a part of the face of the mobile terminal opposite to that where the screen is mounted.

Therefore, the reduction in the thickness of the mobile terminal is increased. In fact, a cavity shape is avoided in the first part of the casing that would cover five faces of the second part of the casing when the mobile terminal is in a retracted position, i.e., when the second part of the casing is housed in the cavity formed in the first part of the casing.

According to a particular embodiment, the displacement means being slide rails, the first element is assembled, at least in part, between the spaces of the cavity intended to receive a part of said slide rails when the mobile terminal is in a retracted position.

Therefore, the resistance of the second part of the casing to keying of the keypad by the user is increased. With this positioning of the first element from among the battery and the printed circuit, the dimensions of the mobile terminal are reduced.

According to a particular embodiment, the terminal comprises another battery and the second part of the casing comprises the printed circuit and this other battery, assembled on both sides of a plane perpendicular to the keypad.

Therefore, the thickness of the mobile terminal is reduced, as well as the dimensions of the first part of the mobile terminal, the dimensions of the second part of the casing being in this case dictated by the size of the keypad, it having keys with a sufficient surface area and/or being sufficiently spaced apart to enable the user to key them with the fingers.

According to a particular embodiment, the second part of the casing comprises the battery, and the keypad signals are transported in a multiplexed manner by the power lines of the battery.

Therefore, the electrical interconnection complexity of the elements of the first and second parts of the casing is reduced.

According to a particular embodiment, the second part of the casing comprises the battery, and the battery and the printed circuit are electrically interconnected via a pair of return springs assembled between the first and second parts of the casing.

Thus, the dimensions, particularly the thickness, of the mobile terminal are reduced by not adding connectors to electrically connect the elements from the first and second parts of the casing. Return springs linked to the relative mobility of the first and second parts of the casing are reused as means to electrically interconnect elements from the first and second parts of the casing.

According to a particular embodiment, the first part of the casing comprises at least one of the elements from the following group, and each element and the cavity are positioned on both sides of a plane perpendicular to the screen:
a camera where the objective lens is on the same face of the mobile terminal as that where the screen is mounted;
a camera where the objective lens is on the face of the mobile terminal opposite to that where the screen is mounted;
an earphone;
a speaker;
a proximity sensor;
an audio output connector;
a light sensor;
a microphone;
a power circuit connector.

Therefore, the reduction in the thickness of the mobile terminal is increased. In fact, superimposition of these elements with the screen, keypad, battery and/or printed circuit is avoided.

According to a particular embodiment, the shape of at least one part of said cavity is adapted to receive, when the mobile terminal is in a deployed position, a projection of a docking station to which the mobile terminal may be physically connected.

Thus, the dimensions, particularly the thickness of the mobile terminal, are reduced by taking advantage of the cavity so that it has a shape adapted for physically connecting the mobile terminal to the docking station. In fact, one doesn't have to resort to shaping another part of the casing to connect the mobile terminal to the docking station. The cavity thus serves as guiding and alignment means when the mobile terminal is connected to the docking station.

According to a particular embodiment, the first part of the casing comprises an acoustic chamber open on said cavity.

Thus, the volume of the acoustic chamber is increased when the mobile terminal is in a deployed position.

The characteristics of the invention mentioned above, as well as others, will appear more clearly upon reading the following description of an example of embodiment, said description being made in relation to the attached drawings, among which:

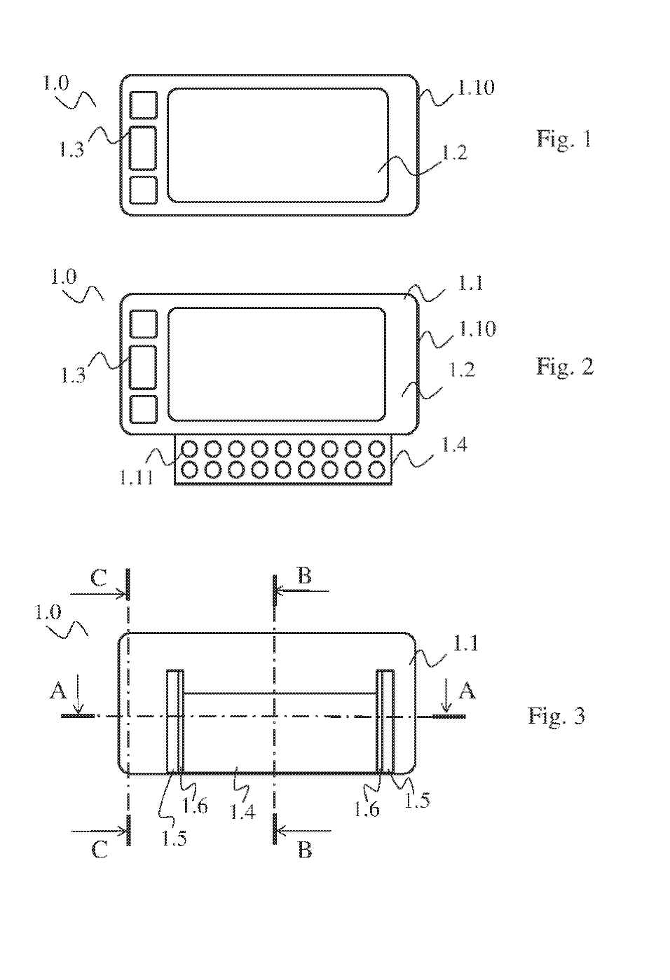

FIG. 1 schematically illustrates a mobile terminal, comprising a casing in two mutually mobile parts, the two parts of the casing being in a retracted position, and in which the invention may be implemented;

FIG. 2 schematically illustrates the mobile terminal from FIG. 1, the two parts of the casing being in a deployed position;

FIG. 3 schematically illustrates an opposite view of the mobile terminal with relation to the representation of FIG. 1;

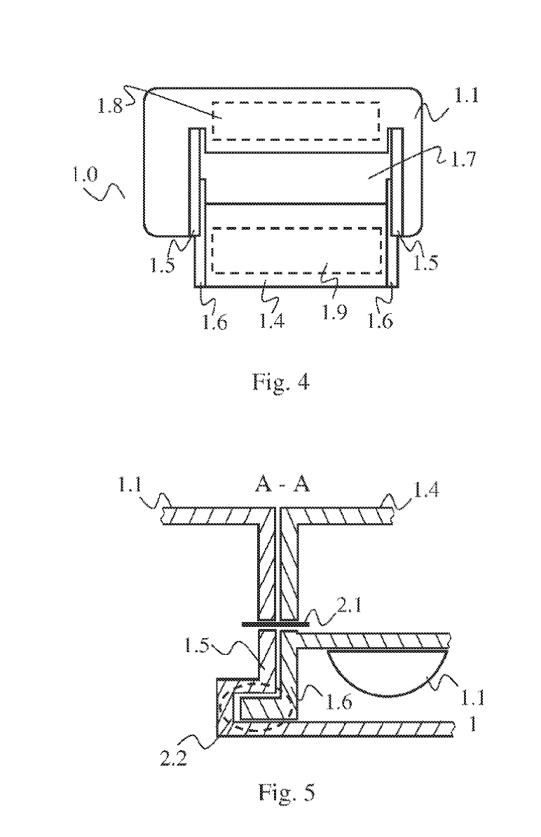

FIG. 4 schematically illustrates an opposite view of the mobile terminal with relation to the representation of FIG. 2;

FIG. 5 schematically illustrates a cross sectional view of one part of the relative displacement means of the two parts of the casing of the mobile terminal, according to an embodiment of the invention;

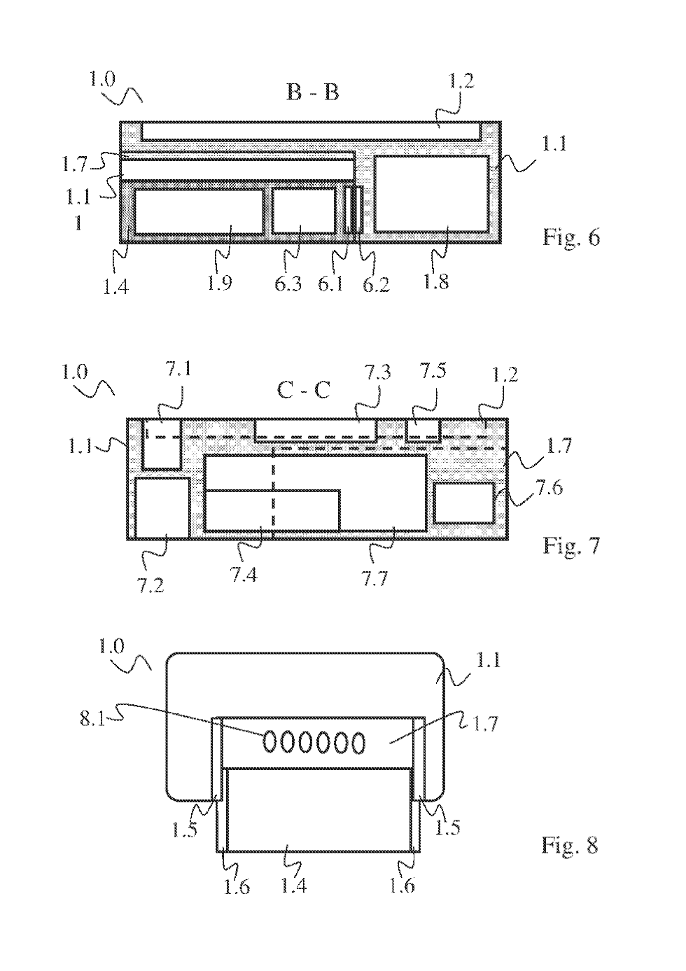

FIG. 6 schematically illustrates a first simplified cross sectional view of the mobile terminal from FIG. 1, the two parts of the casing being in a retracted position;

FIG. 7 schematically illustrates a second simplified cross sectional view of the mobile terminal from FIG. 1, the two parts of the casing being in a retracted position;

FIG. 8 schematically illustrates an opposite view of the mobile terminal with relation to the representation from FIG. 2, the deployed position revealing at least one connector, according to an embodiment of the invention.

FIG. 1 schematically illustrates a mobile terminal 1.0 in which the invention may be implemented.

The mobile terminal 1.0 comprises a casing 1.10 in which is mounted a screen 1.2. A mobile terminal 1.0 user may see on the screen 1.2 graphic objects relative to the applications and interact with them. This interaction may be done directly if screen 1.2 is a touch screen or by means of a set of keys 1.3 or a keypad 1.11.

Mobile terminal 1.0 is for example a cellular radio telephone mobile terminal, a PDA personal digital assistant, a tablet type personal computer, etc. In a preferred embodiment, mobile terminal 1.0 is a cellular radio telephone mobile terminal.

Casing 1.10 comprises a first part and a second part that are mutually mobile. In FIG. 1, the second part of casing 1.10 is housed in a cavity formed in the first part of the casing 1.10. The cavity thus formed appears on a part of a face of the mobile terminal 1.10 perpendicular to that where screen 1.2 is mounted.

When the first and second parts of casing 1.10 are thus positioned, they are in the retracted position. More generally, the mobile terminal 1.0 is also in a retracted position.

The user may slide the second part of the casing 1.10 and deploy it, at least partially, outside of this cavity. The first and second parts of casing 1.10 are then in a deployed position. More generally, the mobile terminal 1.0 is also in a deployed position.

As will be described subsequently, the dimensions, and particularly the thickness, of the mobile terminal 1.0 are reduced since the first part of the casing 1.10 comprises a first element from among the battery and said printed circuit, the second part of the casing 1.10 comprises the second element from among the battery and said printed circuit, and the cavity and this first element are positioned on both sides of a plane perpendicular to screen 1.2. The cavity and this first element are positioned such that the thickness of this first element and the height of the cavity do not entirely accumulate in the thickness of the mobile terminal 1.0. In other words, the space taken in the thickness of the mobile terminal 1.0 by the cavity and this first element has a height of less than the summation of the thickness of this first element and the height of the cavity. In a preferential embodiment, the space taken in the thickness of the mobile terminal 1.0 by the cavity and this first element has a height equal to the maximum between the thickness of this first element and the height of the cavity.

Therefore, superimposition of the most voluminous elements of the mobile terminal 1.0 is avoided, while a sufficient thickness is ensured to the second part of the casing to withstand keying of the keypad by the user.

FIG. 2 schematically illustrates the mobile terminal 1.0 in a deployed position. In this position, the second part 1.4 of casing 1.10 exits, at least partially, from the cavity formed in the first part 1.1 of casing 1.10. The mobile terminal 1.0 then reveals the keypad 1.1 assembled in the second part 1.4 of casing 1.10. The user of the mobile terminal 1.0 may then use the keypad 1.11 to interact with the applications installed on the mobile terminal 1.0.

Keypad 1.11 may be of the numerical type (keypad), of the alphanumerical type (keyboard) or of the gamepad type.

Keypad 1.11 is preferentially assembled on the second part 1.4 of casing 1.10 so as to be visible and accessible, on the same side of the mobile terminal 1.0 as screen 1.2. Therefore, when the mobile terminal 1.0 is in a deployed position, the user may manipulate the keypad 1.11 and simultaneously observe the effects on the screen 1.2.

FIG. 3 schematically illustrates an opposite view of the mobile terminal 1.0 with relation to the representation of FIG. 1.

The second part 1.4 of casing 1.10 is housed in the cavity formed in the first part 1.1 of casing 1.10. The mobile terminal 1.0 is then in a retracted position.

So as to make the first 1.1 and second 1.4 parts of the casing 1.10 mutually mobile, the second part 1.4 of the casing 1.10 comprises displacement means 1.6 and the first part 1.1 of casing 1.10 comprises displacement means 1.5. Displacement means 1.5 and 1.6 cooperate so that the first 1.1 and second 1.4 parts of casing 1.10 are mutually displaced. The first 1.1 and second 1.4 parts of casing 1.10 comprise guiding means to guide their relative displacement. In the embodiment presented in FIG. 3, the displacement means 1.5 and 1.6 take the form of slide rails and merge with the guiding means. Other embodiments may be contemplated, for example by using distinct displacement means and guiding means.

The cavity is preferentially formed such that, when the mobile terminal 1.0 is in a retracted position, it is substantially filled in by the second part 1.4 of casing 1.10.

The cavity is preferentially formed, and the second part 1.4 of casing 1.10 is preferentially disposed such that, when the mobile terminal 1.0 is in a retracted position, a face of the second part 1.4 of casing 1.10 merges with a part of the face of the mobile terminal opposite to that where the screen is mounted. This face of the mobile terminal 1.0 is thus formed in part on a face of the second part 1.4 of casing 1.10, the rest being formed by the face of the first part of casing 1.10 where cavity 1.7 is found. Cavity 1.7 then comprises four faces, one of them being parallel to the screen and the three others being perpendicular to this face parallel to the screen. The cavity thus formed appears on a face of the mobile terminal 1.0 opposite to that where screen 1.2 is mounted, as well as on a part of a perpendicular face. The thickness of mobile terminal 1.0 is thus reduced.

In addition, such a layout enables, when the mobile terminal 1.0 in deployed position is placed on a substantially flat surface, such as a table for example, both the keypad 1.11 and the screen 1.2, or buttons 1.3, to be manipulated, without fear of mobile terminal 1.0 toppling over.

FIG. 4 schematically illustrates an opposite view of the mobile terminal with relation to the representation of FIG. 2.

The second part 1.4 of casing 1.10 partially exits cavity 1.7 formed in the first part 1.1 of casing 1.10. The mobile terminal 1.0 is then in a deployed position.

Mobile terminal 1.0 comprises at least, besides the keypad, screen 1.2 and buttons 1.3, a battery and a printed circuit on which is placed, at least, a processor. This processor is preferentially the central processor of the mobile terminal 1.0, i.e., that which coordinates the different electronic elements of terminal 1.0. On the printed circuit may also be placed one or more memory components and/or a wireless communication circuit and/or another data or signal processing electronic component.

The first part 1.1 of casing 1.10 comprises a first element 1.8 from among the battery and the printed circuit, and the second part 1.4 of casing 1.10 comprises the second element 1.9 from among the battery and the printed circuit. The second part 1.4 of casing 1.10 may comprise other electronic elements. Elements 1.8 and 1.9 are represented in dotted lines in FIG. 4. As described subsequently in relation to FIG. 6, element 1.8 and cavity 1.7 are positioned on both sides of a plane perpendicular to screen 1.2. Cavity 1.7 and element 1.8 are positioned such that the thickness of element 1.8 and the height of cavity 1.7 do not entirely accumulate in the thickness of mobile terminal 1.0. In other words, the space taken in the thickness of mobile terminal 1.0 by cavity 1.7 and element 1.8 has a height of less than the summation of the thickness of element 1.8 and the height of cavity 1.7. In a preferential embodiment, the space taken in the thickness of mobile terminal 1.0 by cavity 1.7 and element 1.8 has a height equal to the maximum between the thickness of element 1.8 and the height of cavity 1.7.

In a particular embodiment, the second part 1.4 of casing 1.10 is substantially parallelepiped and the displacement means 1.5 and 1.6 are slide rails.

In a particular embodiment, as shown in FIG. 4, the element from among the battery and the printed circuit that is placed in the first part 1.1 of casing 1.10 is assembled, at least in part, in a space of this first part 1.1 of casing 1.10 situated between the spaces of cavity 1.7 intended to receive a part of slide rails from the second part 1.4 of casing 1.10 when the mobile terminal 1.0 is in a retracted position. In this manner, the slide rails have a length that is longer than the width of the second part 1.4 of casing 1.10 where keypad 1.11 is positioned. Therefore, the slide rails offer better resistance to keying of the keypad 1.11 by the user. The dimensions of the first part 1.1 of casing 1.10 are also optimized.

FIG. 5 schematically represents a cross-sectional view of part of the relative displacement means of the first 1.1 and second 1.4 parts of casing 1.10 of mobile terminal 1.1. The representation of FIG. 5 is a partial cross sectional view along axis A-A drawn on FIG. 3.

In FIG. 3, the displacement means 1.5 and 1.6 consist of a sliding mechanism. The first part 1.1 of casing 1.10 presents a groove, made in cavity 1.7, that extends substantially over the entire depth of cavity 1.7. Complementarily, the second part 1.4 of casing 1.10 presents a projection substantially extending over its entire length. The groove of the first part 1.1 of casing 1.10 receives the projection of the second part 1.4 of casing 1.10.

As shown in FIG. 5, the displacement means 1.5 and 1.6 are assembled on at least one face of the second part 1.4 of casing 1.10, that is perpendicular to that where keypad 1.11 is assembled. Therefore, displacement means 1.5 and 1.6 are not assembled in the thickness of the mobile terminal 1.0, which is then reduced.

In a preferential embodiment, displacement means 1.5 and 1.6 have surfaces in contact 2.2 loaded with polytetrafluoroethylene, for example of the Teflon (registered trademark) type. Therefore, the relative displacement of the first 1.1 and second 1.4 parts of casing 1.10 is facilitated.

As shown in FIG. 4, a symmetric mechanism is implemented on the opposite face of the second 1.4 part of casing 1.10 and on the opposite face of cavity 1.7.

The mobile terminal 1.0 may also comprise means for maintaining the first 1.1 and second 1.4 parts of the casing either in the retracted position or in the deployed position. A magnet may for example be placed in cavity 1.7 and a metallic element may be placed on the second part, so as to facilitate maintaining the mobile terminal 1.0 in the retracted position. This embodiment is described below in relation to FIG. 6. In addition, a spring catch assembled in cavity 1.7 and a corresponding notch in the second part 1.4 of casing 1.10 may be implemented to maintain the terminal in the deployed position.

The use of this magnet and spring catch in a combined manner facilitates the disconnection of the first 1.1 and second 1.4 parts of casing 1.10. Therefore, in an embodiment in which the second part 1.4 comprises the battery, it may be changed by carrying out this disconnection. This enables placement of a battery access panel other than on the face of the second part 1.4 of casing 1.10, opposite from that where keypad 1.11 is assembled. Therefore, mobile terminal 1.0 may have a face opposite from that where the perfectly smooth screen is mounted, in the retracted position.

In addition, this enables the second part 1.4 of casing 1.10 to be easily changed at a reduced cost. In fact, removing the battery to install it in a new second part 1.4 of casing 1.10 is easier and quicker than removing the printed circuit and installing it in a new second part 1.4 of casing 1.10.

Such a change in the second part 1.4 of casing 1.10 may be implemented in the event of maintenance or repair of mobile terminal 1.0.

Such a change in the second part 1.4 of casing 1.10 may also be implemented to change the type of keypad 1.11. Therefore, the mobile terminal 1.0 user may easily adapt the keypad 1.11 to the application in progress on the mobile terminal 1.0 and with which he interacts via screen 1.2. The user may thus install an alphanumerical keyboard to enter text into an e-mail management application and install a gamepad type keypad to play a game on his mobile terminal 1.0. Therefore, the dimensions of the mobile terminal are reduced since simplified and interchangeable keypads may be used.

In the event where the printed circuit is placed in the first part 1.1 of mobile terminal 1.0, an additional battery also placed in the first part 1.1 of mobile terminal 1.0 may enable this keypad change to be performed without turning mobile terminal 1.0 off.

Mobile terminal 1.0 may also comprise at least one return spring to facilitate the displacement and maintenance, in the retracted and deployed position, of the first 1.1 and second 1.4 parts of casing 1.10.

The second part 1.4 of casing 1.10 may be hinged so as to incline by a predefined angle with relation to the screen, when the mobile terminal 1.0 is in the deployed position. The face of the first part 1.1 of casing 1.10 opposite to that where screen 1.2 is mounted thus forms an outside obtuse angle, i.e., between 90° and 180°, with the face of the second part 1.4 of casing 1.10 opposite that where keypad 1.11 is assembled. Therefore, the hold of the mobile terminal 1.0 and the handling of the keypad 1.11 is improved.

Mobile terminal 1.0 also comprises means to interconnect the first 1.8 and second 1.9 elements, so as to connect the battery to the printed circuit.

In the event where the second part 1.4 of casing 1.10 comprises the printed circuit, an FPC (Flexible Printed Circuit) 2.1 may be used to interconnect the battery to the printed circuit, and the input/output interfaces of the component or components assembled on the printed circuit and those assembled in the first part 1.1 of casing 1.10, such as for example screen 1.2. It is also necessary to convey the signals connected to the management of the keypad 1.11. In a variation of embodiment, a coaxial cable may be used.

In the event where the second part 1.4 of casing 1.10 comprises the battery, the number of signals to be exchanged between the elements of the first part 1.1 of casing 1.10 and those of the second part 1.4 of casing 1.10 are reduced. It is therefore only necessary to convey the electrical energy issued by the battery and the signals connected to managing the keypad 1.11. These signals may for example be multiplexed on the power lines of the battery, which limits the number of electrical contacts between the first 1.1 and second 1.4 parts of casing 1.10.

In a variation of embodiment, it is possible to implement very short range communication means, on the order of a few centimeters, in order to establish a radio link to transmit the signals resulting from keypresses on keypad 1.11.

The transmission of energy issued from the battery from the second part 1.4 of casing 1.10 to the first part 1.1 of casing 1.10 may be implemented in a bifilar manner.

This energy may be transmitted by using a pair of return springs, assembled between the first 1.1 and second 1.4 parts of casing 1.10 and intended to facilitate their relative displacement and their maintenance in retracted or deployed position. The battery terminals are then connected to the respective return springs. The battery and the printed circuit are thus electrically interconnected via this pair of return springs. These springs are preferentially assembled on two faces of the second part 1.4 of casing 1.10 substantially perpendicular to that where keypad 1.11 is assembled, and are disposed symmetrically with relation to a relative axis of translation of the first 1.1 and second 1.4 parts of casing 1.10. These return springs thus disposed facilitate the handling in relative translation of the first 1.1 and second 1.4 parts of casing 1.10, without increasing the dimensions, particularly the thickness, of mobile terminal 1.0.

It is also possible to use “pogo” type pistons to do the interconnection.

This energy may also be transmitted by directly using displacement means 1.5 and 1.6, when they are for example implemented in the form of slide rails. The surfaces in contact 2.2 of these displacement means 1.5 and 1.6 must then be constituted of a conductive material.

FIG. 6 schematically illustrates a first simplified cross sectional view of mobile terminal 1.0 in a retracted position. The cross sectional view represented by FIG. 6 is obtained along the axis B-B drawn on FIG. 3. A 90° clockwise rotation was carried out to facilitate the reading of FIG. 6.

FIG. 6 shows that the first part 1.1 of casing 1.10 comprises screen 1.2 on one of these faces. Cavity 1.7 is formed on the opposite face. Cavity 1.7 appears on this opposite face as well as on one part of a perpendicular face.

The first part 1.1 of casing 1.10 comprises a first element 1.8 from among the battery and the printed circuit. As already mentioned, this first element 1.8 and the cavity 1.7 are positioned on both sides of a plane perpendicular to screen 1.2.

The first part 1.1 of casing 1.10 also comprises a magnet 6.2 present on one face of cavity 1.7, this face being that on which the second part 1.4 of casing 1.10 stands when the terminal is in the retracted position.

The second part 1.4 of casing 1.10 comprises a metallic element 6.1 correspondingly placed to this magnet 6.2. This magnet 6.2 and this metallic element 6.1 maintain the mobile terminal 1.0 in the retracted position. This magnet 6.2 and this metallic element 6.1 may be interchanged.

Keypad 1.11 is assembled on the face of the second part 1.4 of casing 1.10 that appears on the same side of mobile terminal 1.0 as screen 1.2 when mobile terminal 1.0 is in the deployed position.

In addition, the second part 1.4 of casing 1.10 comprises the second element 1.9 from among the battery and the printed circuit.

In a particular embodiment, the first part 1.1 of casing 1.10 comprises the battery and the second part 1.4 of casing 1.10 comprises the printed circuit as well as another battery 6.3. In this case the printed circuit and this other battery 6.3 are positioned on both sides of a plane perpendicular to keypad 1.11. The printed circuit and this other battery 6.3 are positioned such that their respective thicknesses do not entirely accumulate in the thickness of mobile terminal 1.0. In other words, the space taken in the thickness of the second part 1.4 of casing 1.10 by the printed circuit and this other battery 6.3 has a height of less than the summation of their respective thicknesses. In a preferential embodiment, the space taken in the thickness of the second part 1.4 of casing 1.10 by the printed circuit and this other battery 6.3 has a height equal to the maximum of their respective thicknesses.

Therefore, the thickness of the mobile terminal 1.0 is reduced, as well as the dimensions of the first part 1.1 of the mobile terminal 1.0, the dimensions of the second part 1.4 of the casing 1.10 being dictated by the size of the keypad 1.11, it having keys with a sufficient surface area and/or being sufficiently spaced apart to enable the user to key them with the fingers.

FIG. 7 schematically illustrates a second simplified cross sectional view of mobile terminal 1.0 in a retracted position. The cross sectional view represented by FIG. 7 is obtained along the axis C-C drawn on FIG. 3. A 90° counterclockwise rotation was carried out to facilitate the reading of FIG. 7.

Screen 1.2 and cavity 1.7 are represented in dotted lines in FIG. 7.

FIG. 7 shows that the first part 1.1 of casing 1.10 comprises:
a camera 7.1 where the objective lens is on the same face of the mobile terminal 1.0 as that where the screen 1.2 is mounted;
a camera 7.2 where the objective lens is on the face of the mobile terminal 1.0 opposite to that where the screen 1.2 is mounted;
a speaker 7.4, assembled in an acoustic chamber 7.7 formed in the first part 1.1 of casing 1.10;
an earphone 7.3;
a proximity sensor 7.5;
a light sensor;
an audio output connector 7.6.

The first part 1.1 of casing 1.10 also comprises, for example disposed in a space of the first part 1.1 of casing 1.10 situated on the other side of cavity 1.7:
a microphone;
a power circuit connector.

The first part 1.1 of casing 1.10 may comprise one or more of these elements. The first part 1.1 of casing 1.10 may comprise other electronic elements.

Each of these elements is assembled in the first part of the casing so that they are non-superimposed on screen 1.2 and cavity 1.7. Each element from the list above and cavity 1.7 is then positioned on both sides of a plane perpendicular to the screen. Preferentially, each element from the list above and cavity 1.7 is positioned on both sides of a plane perpendicular to the screen that is itself perpendicular to the plane on both sides of which cavity 1.7 and the first element 1.8 are positioned. The thickness of mobile terminal 1.0 is thus reduced.

FIG. 8 schematically illustrates an opposite view of the mobile terminal 1.0 with relation to the representation from FIG. 2, according to an embodiment of the invention.

In FIG. 8, mobile terminal 1.0 is represented in a deployed position. Mobile terminal 1.0 then reveals at least one connector 8.1.

This or these connector(s) 8.1 enable the mobile terminal to be connected to a docking station that has one or more corresponding connectors. Such a docking station provides extended functionalities to the mobile terminal 1.0. For example, the docking station enables, with mobile terminal 1.0, a larger size keypad or screen to be used, or provides additional storage capacities to mobile terminal 1.0.

The docking station may for example be installed in a vehicle and thus enables the mobile terminal 1.0 to be used in “hands free” mode.

The shape of cavity 1.7 is thus adapted to receive, when mobile terminal 1.0 is in the deployed position, a projection formed on the docking station. At least one part of cavity 1.7 then has a shape complementary to this projection.

In other words, the part of cavity 1.7 thus revealed when mobile terminal 1.0 is in the deployed position acts as guiding means to physically connect mobile terminal 1.0 to the docking station. It enables the alignment of the connector or connectors of the mobile terminal 1.0 with that or those of the docking station. The physical connection is facilitated.

In addition, by taking advantage of cavity 1.7 arranged to receive the second part 1.4 of casing 1.10 when mobile terminal 1.0 is in the retracted position, the dimensions of the mobile terminal 1.0 are reduced. In fact, if cavity 1.7 was not used in this way, another part of casing 1.10 should be arranged to correspond to a projection or a cavity formed in the docking station.

In a particular embodiment, the acoustic chamber 7.7 is open on cavity 1.7. Thus, when the mobile telephone is deployed, the acoustic chamber is increased by the volume of the cavity 1.7 made free by deployment of the second part 1.4 of casing 1.10. When cavity 1.7 is opened on the face opposite to the screen, as shown in FIG. 4, and as mobile terminal 1.0 in the deployed position is placed on a substantially flat surface, such as a table for example, the volume of the acoustic chamber 7.7 is increased. In fact, in this configuration, the substantially flat surface on which mobile terminal 1.0 is placed substantially closes cavity 1.7. Therefore, the mobile terminal 1.0 user may deploy the second part 1.4 of casing 1.10, place the mobile terminal 1.0 on a table to use it in “hands free” mode and benefit from an increased sound range. This is made possible by the fact that cavity 1.7 does not extend over the entire width, or more generally over the entirety of one of the three dimensions, of the mobile terminal 1.0.

1-11. (canceled)

12. A mobile terminal comprising:
a casing,
a plurality of electronic elements being at least a screen, a keypad and a battery, and
a printed circuit on which at least a central processor of the mobile terminal is placed, said central processor being configured for coordinating the plurality of electronic elements of said terminal, said printed circuit being connected to said battery,
said casing comprising a first part comprising the screen and a second part comprising the keypad, the second part of the casing being assembled in a mobile manner by means of displacement means, said displacement means being slide rails, between a retracted position and a deployed position in a cavity formed in the first part of the casing, said first part of the casing comprising a first element from among the battery and said printed circuit, said first element and said cavity being positioned on opposite sides of a plane perpendicular to the screen, said second part of the casing comprising the second element from among the battery and said printed circuit.

13. The mobile terminal according to claim 12, wherein the keypad is assembled substantially parallel to the screen and wherein the displacement means are assembled on at least one face of said second part of the casing substantially perpendicular to that where the keypad is located.

14. The mobile terminal according to claim 12, the screen being mounted on a face of the mobile terminal, wherein a face of said second part of the casing merges with a part of the face of the mobile terminal opposite to that where the screen is mounted.

15. The mobile terminal according to claim 12, wherein said first element is assembled, at least in part, between spaces of said cavity intended to receive a part of said slide rails when the mobile terminal is in the retracted position.

16. The mobile terminal according to claim 12, wherein the terminal comprises another battery, and in that said second part of the casing comprises said printed circuit and said other battery, assembled on opposite sides of a plane perpendicular to the keypad.

17. The mobile terminal according to claim 12, wherein said second part of the casing comprises the battery, and wherein keypad signals are transported in a multiplexed manner on power lines of the battery.

18. The mobile terminal according to claim 12, wherein said second part of the casing comprises the battery, and wherein the battery and the printed circuit are electrically interconnected via a pair of return springs assembled between said first and second parts of the casing.

19. The mobile terminal according to claim 12, wherein said first part of the casing comprises at least one of the elements from the following group, and in that each element and said cavity are positioned on both sides of a plane perpendicular to the screen:
a camera where the objective lens is on the same face of the mobile terminal as that where the screen is mounted;
a camera where the objective lens is on the face of the mobile terminal opposite to that where the screen is mounted;
an earphone;
a speaker;
a proximity sensor;
an audio output connector;
a light sensor;
a microphone;
a power circuit connector.

20. The mobile terminal according to claim 12, wherein the shape of at least one part of said cavity is adapted to receive, when the mobile terminal is in a deployed position, a projection of a docking station to which the mobile terminal may be physically connected.

21. The mobile terminal according to claim 12, wherein the first part of the casing comprises an acoustic chamber open towards said cavity.

22. The mobile terminal according to claim 12, wherein the second part of the casing is mobile parallel to the screen.
